(19) United States
(12) Patent Application Publication
(10) Pub. No.: US 2015/0097569 A1
(43) Pub. Date: Apr. 9, 2015

(54) Validating Operation of an Electronic Marker Locator

(71) Applicant: Radiodetection Limited, Bristol (GB)

(72) Inventors: Timothy Longley, Bristol (GB); Richard David Pearson, Bristol (GB)

(21) Appl. No.: 14/046,586

(22) Filed: Oct. 4, 2013

(51) Int. Cl. G01V 3/08

(52) U.S. Cl. CPC G01V 3/087
USPC 324/327

(57) ABSTRACT

A locator for locating a buried electromagnetic marker is operable to generate a test signal in order to validate that the locator is operating in accordance with calibration data. The locator comprises a transmission antenna and a first reception antenna. The transmission antenna is configured to generate a first oscillatory magnetic field to couple with an electromagnetic marker and the first reception antenna is configured to receive an oscillatory magnetic field emitted by the electromagnetic marker. In order to validate the operation of the locator, the transmission antenna is configured to generate a test oscillatory magnetic field, and the first reception antenna is configured to receive the test oscillatory magnetic field and thereby generate a first detected test signal.

### FIELD OF THE INVENTION

Embodiments of the present invention relate to locators for locating buried electronic markers. In particular, embodiments of the present invention relate to the validation of the operation of locators for locating electronic markers.

### BACKGROUND

Buried electronic markers are used to indicate the location of a buried structure or utility. A buried marker is made from a circular coil that is arranged in a resonant circuit and designed to resonate at a specific frequency. An oscillatory electric current may be induced in this circuit by an externally applied pulse or pulses of magnetic flux linking the coil. The oscillatory current in the coil gives rise to an oscillatory magnetic field around the coil. The presence of this oscillatory magnetic field may be detected, allowing the position of the marker to be determined. The axis of the coil in the buried electronic marker is arranged to be oriented vertically so that the location of the buried marker may be found directly beneath the position where the magnitude of the oscillatory magnetic field is detected to be at a maximum. The depth of the electronic marker may be estimated by detecting the signals transmitted from the marker.

### SUMMARY OF THE INVENTION

According to a first aspect of the present invention a locator for locating a buried electromagnetic marker has a validation mode in which the operation of a transmission antenna of the locator can be validated against calibration data. The locator comprises: a transmission antenna for generating a first oscillatory magnetic field to couple with an electromagnetic marker; and a first reception antenna for receiving an oscillatory magnetic field emitted by the electromagnetic marker. In order to validate the operation of the transmission antenna, the transmission antenna is configured to generate a test oscillatory magnetic field, and the first reception antenna is configured to receive the test oscillatory magnetic field and thereby generate a first detected test signal. The locator further comprises a first analogue to digital converter configured to generate a first digitised test signal from the first detected test signal, the first digitised test signal is indicative of the test oscillatory magnetic field received by the first reception antenna.

In an embodiment the locator further comprises a memory storing calibration data; and a processor configured to calculate a validation value from the first digitised test signal and determine if the validation value is within predetermined limits of the calibration data. In this embodiment the validation of the locator is carried out on the locator itself.

In an embodiment the locator further comprises a second reception antenna for receiving an oscillatory magnetic field emitted by the electromagnetic marker, the second reception antenna being configured to receive the test oscillatory magnetic field and thereby generate a second detected test signal, and a second analogue to digital converter configured to generate a second digitised test signal from the second detected test signal, the second digitised test signal being indicative of the test oscillatory magnetic field received by the second reception antenna. In this embodiment the signals detected by both of the reception antenna may be used in the validation process.

In an embodiment the locator further comprises: a memory storing calibration data; and a processor configured to calculate a validation value from the first digitised test signal and the second digitised test signal and determine if the validation value is within predetermined limits of the calibration data.

In an embodiment the first oscillatory magnetic field comprises a plurality of pulses having a first pulse width, and the test oscillatory magnetic field comprises a plurality of pulses having a second pulse width, the second pulse width being shorter than the first pulse width.

In an embodiment the first oscillatory magnetic field comprises a plurality of pulses having a first amplitude, and the test oscillatory magnetic field comprises a plurality of pulses having a second amplitude, the second amplitude being smaller than the first amplitude.

In embodiments, the power of the test oscillatory magnetic field is reduced compared to the power of the first oscillatory magnetic field. This avoids the reception antenna becoming saturated by the test oscillatory magnetic field.

In an embodiment the locator further comprises an interface configured to transfer the first digitised test signal to a coupled computing device. In this embodiment the validation is carried out on the coupled computing device.

According to a second aspect of the present invention a method of validating the operation of a locator for locating a buried electromagnetic marker comprises:

controlling a transmission antenna of the locator to generate a test oscillatory magnetic field; controlling a reception antenna of the locator to receive the test oscillatory magnetic field and thereby generate a first detected test signal; calculating a validation value from the first detected test signal; and determining if the validation value is within predetermined limits of calibration data.

In an embodiment the method further comprises generating a certificate if the validation value is within the predetermined limits of the calibration data.

In an embodiment the method further comprises determining an identifier of locator and retrieving the calibration data from a remote database using the identifier of the locator.

In an embodiment the transmission antenna of the locator is configured to generate a first oscillatory magnetic field to couple with an electromagnetic marker and the test oscillatory magnetic field comprises a plurality of pulses having a second pulse width, the second pulse width being shorter than a first pulse width.

In an embodiment the transmission antenna of the locator is configured to generate a first oscillatory magnetic field to couple with an electromagnetic marker and the test oscillatory magnetic field comprises a plurality of pulses having a second amplitude, the second amplitude being smaller than the first amplitude.

According to a third aspect of the present invention a computer readable carrier medium carrying computer readable instructions is provided.

According to a fourth aspect of the present invention a method of validating the operation of a locator for locating a buried electromagnetic marker, the method comprises: generating a test oscillatory magnetic field in a transmission antenna of the locator; receiving the test oscillatory magnetic field in a reception antenna of the locator and thereby generating a first detected test signal; calculating a validation value from the first detected test signal; and determining if the validation value is within predetermined limits of calibration data.

In an embodiment the method further comprises disabling the locator if the validation value is not within the predetermined limits of the calibration data.

### BRIEF DESCRIPTION OF THE DRAWINGS

In the following, embodiments of the invention will be described by way of example with reference to the accompanying drawings in which

FIG. 1 shows an electronic marker locator according to an embodiment of the present invention;

FIG. 2 shows an electronic marker locator according to an embodiment of the present invention;

FIG. 3 shows method carried out on an electronic marker locator to determine the depth of a buried electronic marker in a marker locate mode;

FIGS. 4a to 4c show the timing of signals transmitted and received by an electronic marker locator in a marker locate mode;

FIG. 5 shows a method of validating the operation of an electronic marker locator according to an embodiment of the present invention;

FIG. 6 shows the control of a transmission antenna in an electronic marker locator in an embodiment of the present invention;

FIGS. 7a to 7c show the test signals transmitted and received in embodiments of the present invention;

FIG. 8 shows a locator according to an embodiment of the present invention in which a validation method is carried out when the locator is coupled to a computing device;

FIG. 9 shows a system for validating the operation of the locator shown in FIG. 8;

FIG. 10 shows a method carried out on a computing device in the system shows in FIG. 9; and

FIGS. 11a and 11b show a locator according to an embodiment with a foldable transmission antenna.

### DETAILED DESCRIPTION

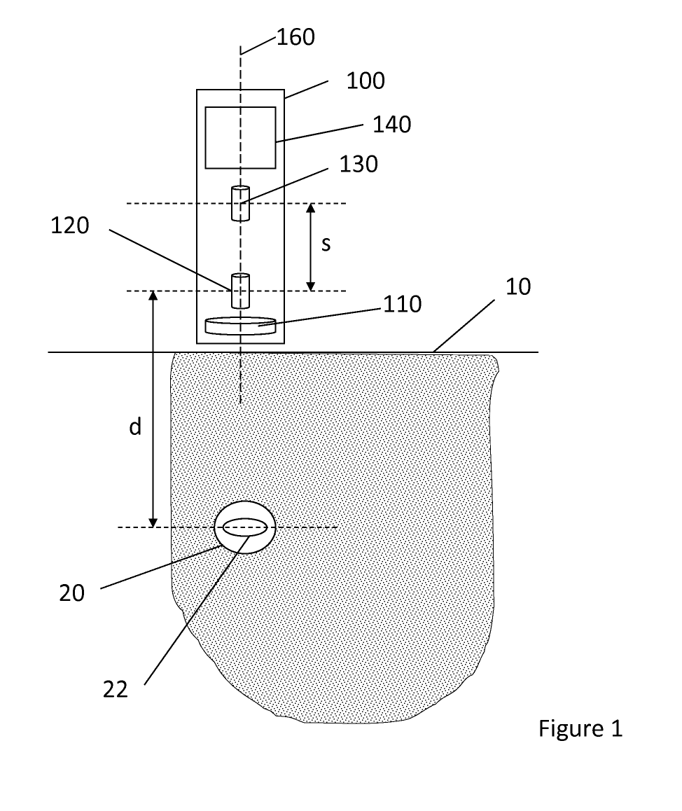

FIG. 1 shows an electronic marker locator 100. An electronic marker 20 is buried below ground level 10. The electronic marker 20 comprises a resonant circuit formed from a coil 22 and a capacitor. The electronic marker 20 has a resonant frequency, the value of which is dependent on the capacitance of the capacitor and the inductance of the coil 22.

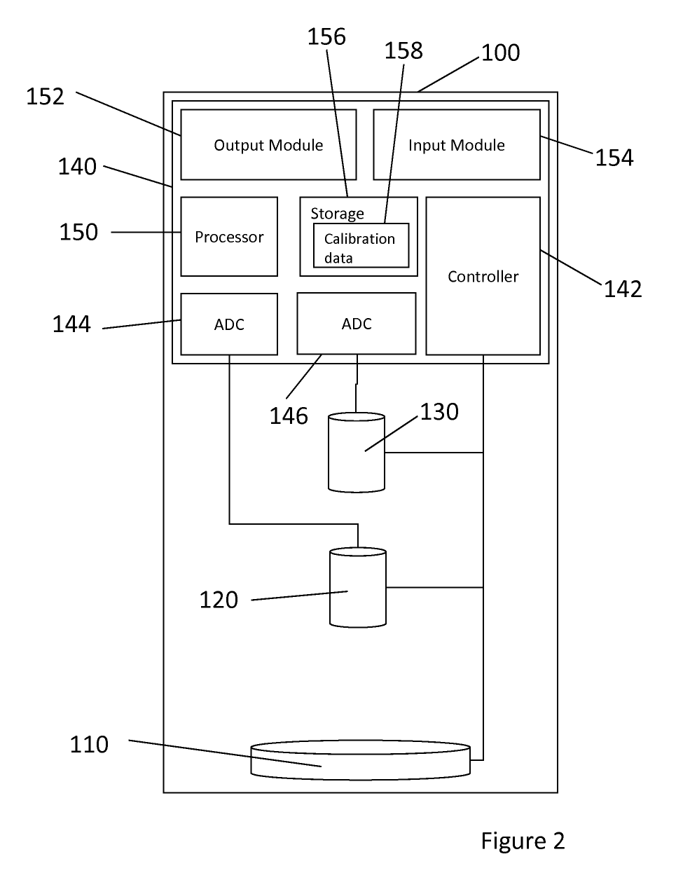

The locator 100 comprises a transmission antenna 110, a first reception antenna 120 and a second reception antenna 130. The locator 100 has control and processing module 140 which controls the antennas and processes the signals received from the antennas. The control and processing module 140 is described in more detail with reference to FIG. 2 below.

The locator 100 has a major axis 160. The transmission antenna 110, the first reception antenna 120 and the second reception antenna 130 are arranged such that their magnetic axes are parallel to the major axis 160. As shown in FIG. 1, the locator is used with the major axis 160 perpendicular to the ground plane 10.

The second reception antenna 130 is separated from the first reception antenna 120 by a distance s along the major axis 160.

In use, the transmission antenna 110 transmits energy to the electronic marker 20 as an oscillating magnetic field. The frequency of the oscillating magnetic field is selected to match the resonant frequency of the resonant circuit in the electronic marker 20. After the transmission antenna 110 stops transmitting, the first reception antenna 120 and the second reception antenna 130 detect signals received from the electronic marker 20. From the ratio R of the signal strengths and the known value s of the separation of the first reception antenna 120 and the second antenna 130 the depth d of the electronic marker 20 is calculated according to the following formula:

$$d = \frac{s}{( {R}^{\frac{1}{3}} - 1 )}$$

The derivation of the above formula is described in United Kingdom Patent Application number 1308550.1, the content of which is incorporated herein by reference.

The depth at which a marker can be located depends on the strength of the transmitted signal. If the transmission antenna does not function within the factory calibration then the depth at which markers can be located may be reduced.

Embodiments of the present invention provide methods of performing a validation test on a locator to check that the transmission antenna is operating within predetermined limits of factory calibration data.

FIG. 2 shows the control and processing module 140 of the electronic marker locator 100 in more detail. The control and processing module 140 comprises a controller 142, a first analogue to digital converter (ADC) 144, a second analogue to digital converter 146, a processor 150, an output module 152, an input module 154, and storage 156.

The controller 142 is coupled to the transmit antenna 110, the first reception antenna 120 and the second reception antenna 130. The controller 142 is configured to control the transmit antenna 110, the first reception antenna 120 and the second reception antenna 130. The controller 142 controls the antennas to operate in one of two modes: a marker locate mode and a validation mode.

In the marker locate mode, the controller 142 controls the transmit antenna 110 to transmit signals to a buried marker.

In the validation mode, the controller 142 controls the transmit antenna 110 to transmit signals directly to the first reception antenna 120 and the second reception antenna 130 in order to validate that the transmit antenna 110 is operating within predetermined limits of factory calibration data.

The storage 156 stores calibration data 158. The calibration data 158 is generated in the factory when the locator is calibrated.

In a marker locate mode, the controller 142 is configured to cause the transmit antenna 110 to transmit an oscillating signal to the electronic marker. When the locator is in the marker locate mode, the controller 142 is also configured to switch the first reception antenna 120 and the second reception antenna 130 to a mode in which they do not produce an output signal in response to a magnetic field. The reception antennas are switched to this mode when the transmission antenna 110 is transmitting to the electronic marker so that the reception antennas do not directly detect the signal transmitted by the transmission antenna 110.

U.S Pat. No. 6,617,856, the content of which is incorporated herein by reference, describes electronic marker locator system and method with one receive antenna. The processing associated with the signals from each of the reception antennas in the electronic marker locator 100 shown in FIG. 2 may be implemented as described in U.S. Pat. No. 6,617,856.

In the marker locate mode, the controller 142 may be configured to cause the transmission antenna 110 to transmit a sequence of pulses. While the transmission antenna 110 transmits the sequence of pulses, the reception antennas are switched to a mode in which they do not detect the pulses transmitted by the transmission antenna 110. After the sequence of pulses has been transmitted by the transmission antenna, the controller 142 switches the first reception antenna 120 and the second reception antenna 130 into a mode in which they are sensitive to magnetic signals transmitted from the electronic marker.

The first reception antenna 120 is connected to the first ADC 144. The first reception antenna 120 is configured to produce a first analogue signal in response to an oscillating magnetic field. The first ADC 144 is configured to digitise the first analogue signal and produce a first digital signal.

The second reception antenna 130 is connected to the second ADC 146. The second reception antenna 120 is configured to produce a second analogue signal in response to an oscillating magnetic field. The second ADC 146 is configured to digitise the second analogue signal and produce a second digital signal.

The processor 150 is configured to receive the first and second digital signals and to calculate an estimate of the depth of the electronic marker using the ratio of the magnitudes of the magnetic field detected by the first reception antenna 120 and the second reception antenna 130.

The output module 152 is coupled to a display which provides an indication of the calculated depth as a numeric value.

The input module 154 allows a user to input a selection of the type of marker to be located. The table below shows the resonant frequencies for markers associated with different types of utility.

| Application | Colour | Frequency |
|---|---|---|
| Power | Red | 169.8 kHz |
| Water | Blue | 145.7 kHz |
| Sanitary | Green | 122.5 kHz |
| Telephone | Orange | 101.4 kHz |
| Gas | Yellow | 83.0 kHz |
| Cable TV | Orange/Black | 77.0 kHz |

The input module 154 is configured to allow a user to select the frequency of the electronic markers being located.

In an embodiment, the processor and the controller are implemented as a single module.

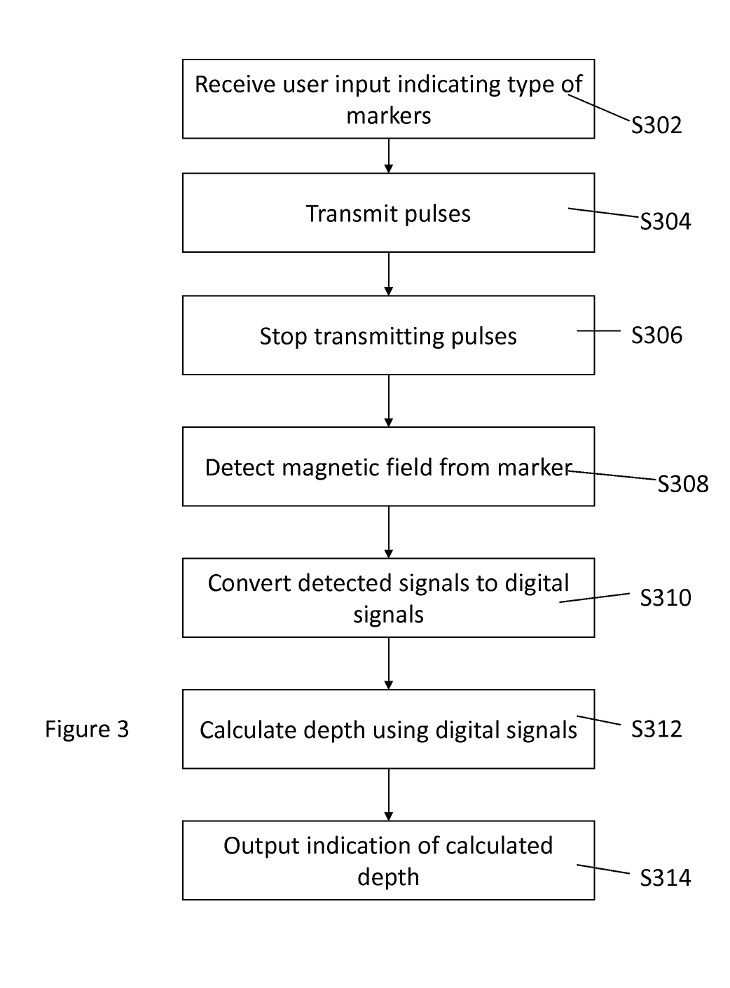

FIG. 3 is a flowchart showing a method carried out by a locator in a marker locate mode.

In step S302 a user input indicating the type of electronic markers to be located is received. In step S304, the controller causes the transmission antenna to transmit a pulse or a series of pulses having a frequency corresponding to the selected type of electronic markers. While the transmission antenna is transmitting, the reception antennas are switched to a mode in which they to do not output a signal. During step S304, if there is an electronic marker of the selected type below the locator, an oscillatory current at the resonant frequency of the marker will be induced in the marker.

In step S306, the controller causes the transmission antenna to stop transmitting. In step S308 the reception antennas are switched by the controller into a mode in which they can detect magnetic fields. The oscillatory current in the electronic marker decays and the electronic marker produces an oscillating magnetic field at its resonant frequency. The reception antennas detect the magnetic field produced by the electronic marker.

In step S310 the ADCs convert the analogue signals produced by the reception antennas into digital signals.

In step S312 the processor calculates the depth of the electronic marker from the ratio of the field strength detected by the first receive antenna and the field strength detected by the second receive antenna.

In step S314 the output module outputs an indication of the calculated depth.

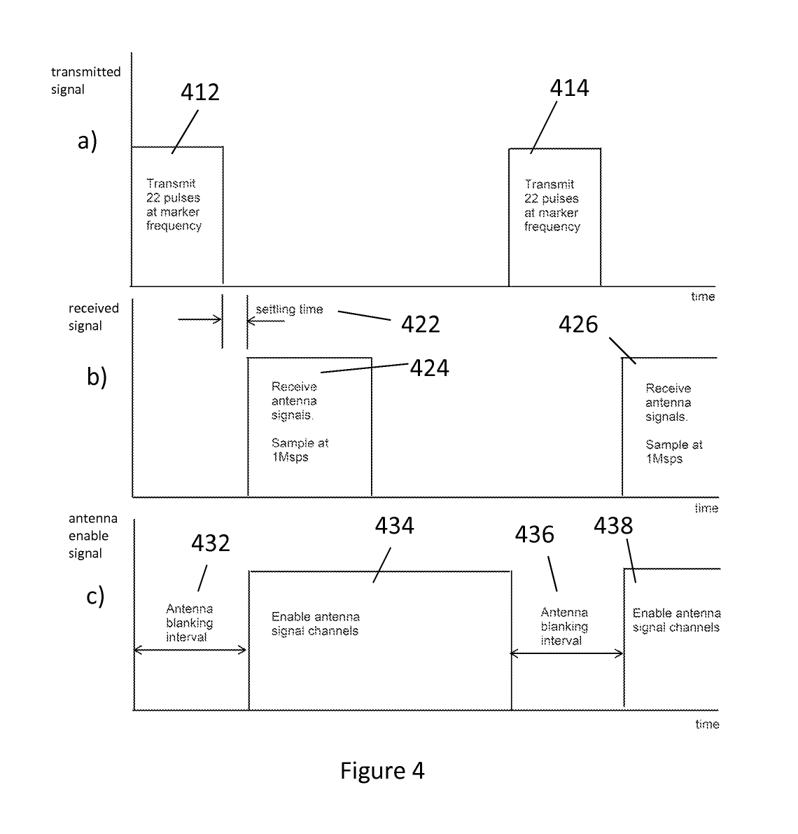

FIGS. 4a to 4c show the timing of the signals transmitted and received by the transmission antenna and the first and second receive antennas in the marker locate mode.

FIG. 4a shows the signals output by the transmission antenna. The controller controls the transmission antenna to transmit a first series 412 of pulses at the selected marker frequency. The first series 412 of pulses includes 22 pulses.

FIG. 4b shows the signals received by the first and second reception antennas. A settling time 422 is allowed to elapse before the first and second antennas are switched into a receive mode by the controller. Once the settling time 422 has elapsed, the first and second antennas receive antenna signals 424. The received signals are sampled at 1 Msps by the first and second ADCs.

The sampling rate of the ADC may be varied. The sampling rate of the ADC must be sufficient to meet the Nyquist sampling criterion but there is no upper limit other than the sample rate capability of the ADC and the processing capability and power consumption of the DSP versus the system power budget.

FIG. 4c shows the timing of the control of the reception antennas by the controller. The controller switches the antennas into a mode where signals are not detected for a first antenna blanking interval 432. The first antenna blanking interval comprises the time that the transmit antenna is transmitting the first series of pulses 412 and the settling time 422. Once the settling time has elapsed, the reception antenna channels are enabled for a first reception time period 434.

As can be seen from FIG. 4c, the first reception time period 434 extends beyond the time that the first and second antennas receive signals 424. During the additional time, the processing of the received signals may take place, and/or signals emitted from buried conductors may be detected and processed as discussed below.

At the end of the first reception time period 434, the next cycle begins. The controller causes the transmission antenna to transmit a second series of pulses 414. Then after a settling time has elapsed, the reception antennas receive the signals 426 transmitted by the electronic marker. The controller switches the reception antennas into a blanked mode during a second antenna blanking interval 436 while the transmission antenna is transmitting and during the settling period. Following the second antenna blanking interval 436, the receive antennas are enabled for a second reception time period 438.

The repetition rate of the transmit bursts is a parameter that is a trade-off between power consumption from the battery and the signal-to-noise ratio of the detected signal. Given the need to provide “real-time” operation to enable the user to sweep the Locator over an area of interest in search of buried markers, the optimum burst rate is typically between 100 and 1000 per second.

In the embodiment described above in relation to FIGS. 4a-c, the first and second series of pulses each include 22 pulses. The number of pulses in the series may be varied. The preferred range of numbers of pulses is related to the exponential time constant of the build-up of signal current in the marker in response to an applied magnetic field that is alternating at the resonant frequency of the marker. Too few pulses results in a weak return signal from the marker. Beyond a certain number of pulses there is little additional signal to be gained by adding more pulses. Adding more pulses is wasteful of battery power. The optimum number of pulses usually lies in the range from approximately 16 to 36 pulses.

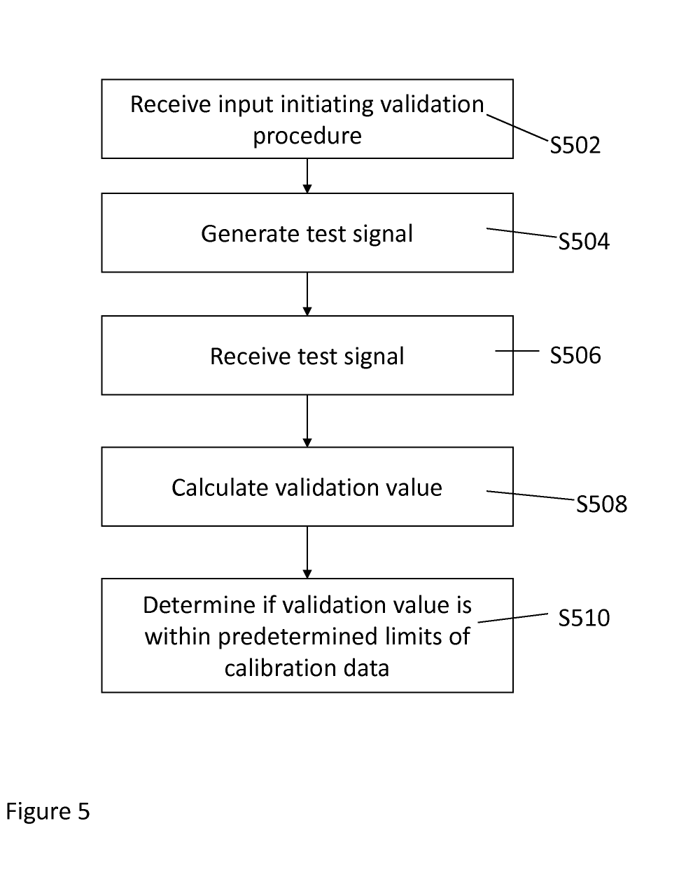

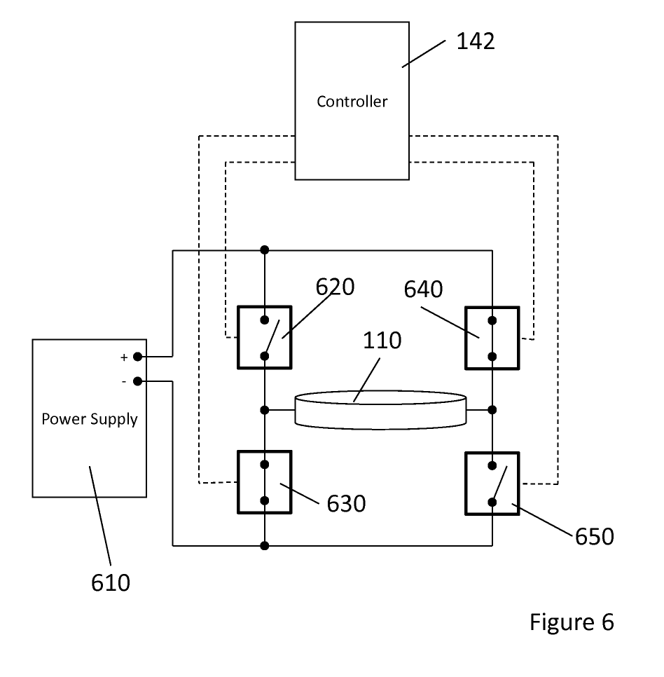

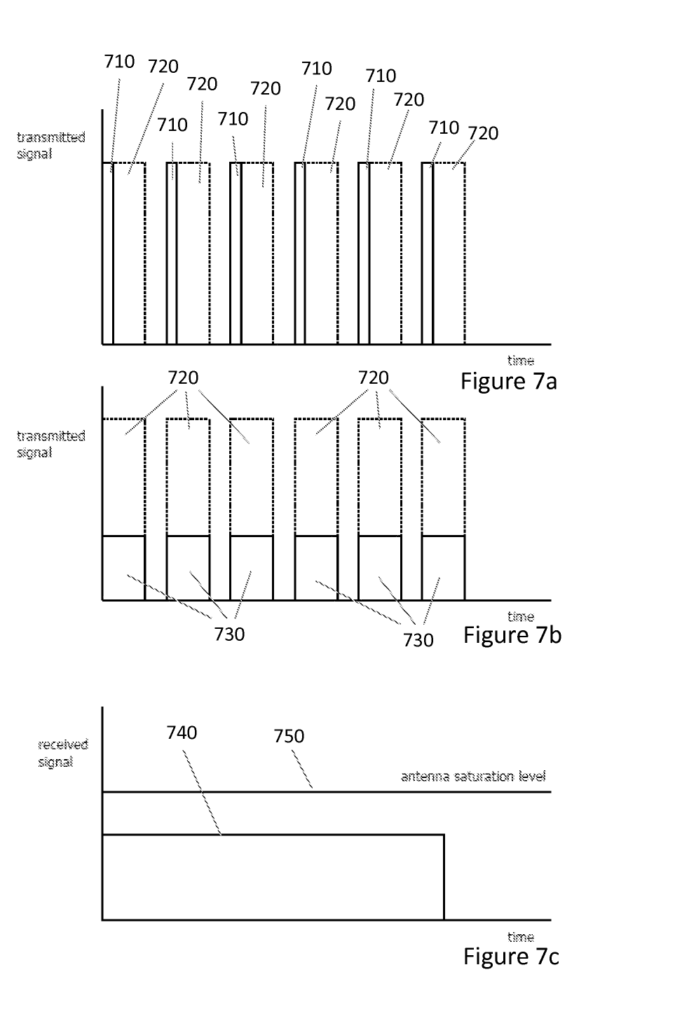

FIG. 5 shows a method carried out by the marker in a validation mode. In step S502, an input is received initiating the validation procedure. In step S504, the transmission antenna generates a test signal. The test signal is an oscillatory magnetic field. In step S506, the test signal is received by the reception antennas. Here it is noted that in the validation mode, the test signal is received directly by the reception antennas from the transmission antenna. This means that the antenna blanking described above in relation to FIG. 4c is not required in the validation mode. In embodiments, the power of the test signal transmitted by the transmission antenna may be reduced to avoid saturation of the reception antennas. This is described in more detail with reference to FIGS. 6 and 7 below.

In step S508 the processor calculates a validation value from the strengths of the detected signals. In step S510 the processor determines whether the validation value is within predetermined limits of the calibration data 158 stored in the storage 156.

The results of the validation test are conveyed to the user via the output module 152. If the locator fails the validation test a warning may be displayed to the user. Alternatively, or additionally, the locator may be locked to prevent its use until the locator is recalibrated and the validation test is passed.

FIG. 6 shows the control of the transmission antenna in an embodiment. A power supply 610 has a positive terminal (+) and a negative terminal (−). Four switches 620 630 640 and 650 in an H-bridge formation connect the power supply 610 to the transmission antenna 110. The controller controls the switches so that two switches are open and two are closed so that a current flows through the transmission antenna in one direction. As shown in FIG. 6, a first switch 620 is open and a second switch 630 is closed so the one connection to the transmission antenna 110 is connected to the negative terminal of the power supply 610. A third switch 640 is closed and a fourth switch 650 is open so the second connection to the transmission antenna is connected to the positive terminal of the power supply 610. The controller 142 controls the direction which current flows through the transmission antenna 110 by selectively opening and closing pairs of the switches.

In one embodiment the switches are MOSFETs, though other transistors or switching devices can be used.

The controller controls the switching of the MOSFETs to provide the required output signal on the transmission antenna. The control signals can be altered to narrow the pulses. This is done by a software change in the controller. The narrowing of the pulse reduces the power transmitted by the transmission antenna.

Another method of reducing the power is by reducing the power supply level.

The control signal can be altered to change the transmit frequency to any marker ball frequency or to other non-marker ball frequencies. In one embodiment only one marker ball frequency will be used.

The required signal can be generated by other means like a half-bridge or a linear amplifier circuit.

FIG. 7a shows the test signal in an embodiment. FIG. 7a shows the pulses 710 of the test signal and also the pulses 720 of the locate mode for comparison. The pulses 710 of the test signal are shown as solid lines and the pulses 720 of the locate mode are shown in broken lines. As shown in FIG. 7a, the controller controls the transmission antenna to transmit the test signal as a series of pulses 710 having a narrower pulse width compared to the pulses 720 in the locate mode. The pulses 710 of the test signal have an equal height to the pulses 720 of the locate mode.

FIG. 7b shows the test signal in an alternative embodiment. As shown in FIG. 7b, the controller controls the transmission antenna to transmit pulses 730 with a lower height than the pulses 720 in the locate mode. This may be achieved by reducing the level of the power supply.

FIG. 7c shows the signal received by the reception antennas in for either of the signals shown in FIG. 7a and FIG. 7b. As shown in FIG. 7c, the received power 740 is lower the antenna saturation level 750. This means that the reception antennas are not saturated and the power of the transmitted signals can be determined.

In the embodiment described above, the validation test is carried out on the locator. In an alternative embodiment, parts of the validation test are carried out by a computing device such as a personal computer, tablet or smartphone.

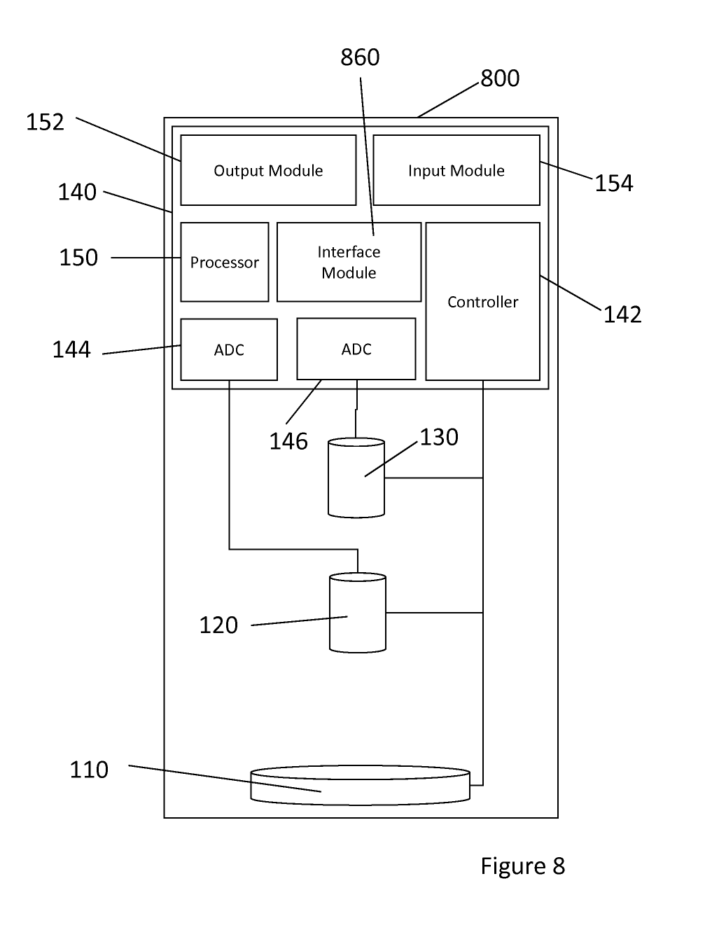

FIG. 8 shows a locator according to an embodiment in which the validation test is carried out when the locator is coupled to a computing device. The locator 800 comprises a control and processing module 140, a transmission antenna 110, a first reception antenna 120 and a second reception antenna 130. The transmission antenna 110, the first reception antenna and the second reception antenna are as described above in relation to FIGS. 1 and 2.

The control and processing module 140 comprises a controller 142, a first analogue to digital converter (ADC) 144, a second analogue to digital converter 146, a processor 150, an output module 152, an input module 154, and an interface module 860.

The controller 142, the first ADC 144, the second ADC 146, the output module 152 and the input module 152 are as described above in relation to FIG. 2. The processor 150 processes signals in the locate mode as described above in relation to FIGS. 3 and 4.

The interface module 860 is a wired or wireless interface which allows the locator 800 to communicate with a computing device. For example the interface module may be a wired interface such as universal serial bus (USB) interface, or a wireless interface such as a bluetooth or wi-fi interface.

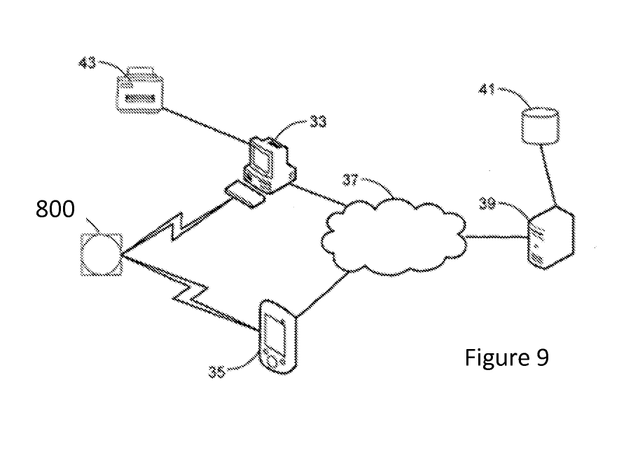

FIG. 9 shows a system for validating the operation of the locator of FIG. 8. The locator 800 communicates with a personal computer 33, or a smartphone 35 using the interface module 860. In this embodiment the locator 800 communicates over a wireless connection with the personal computer 33 or the smartphone 35, however in other embodiments the connection may be a wired connection.

The personal computer 33 and the smartphone 35 are connected via a network 37 such as the internet to a server 39. The server 39 is coupled to a storage device 41 which stores calibration data for the locator 800. The storage device 41 may store calibration data for a plurality of locators. The calibration data may be searchable using an identifier, for example a serial number, of the locator. A printer 43 is coupled to the personal computer 33.

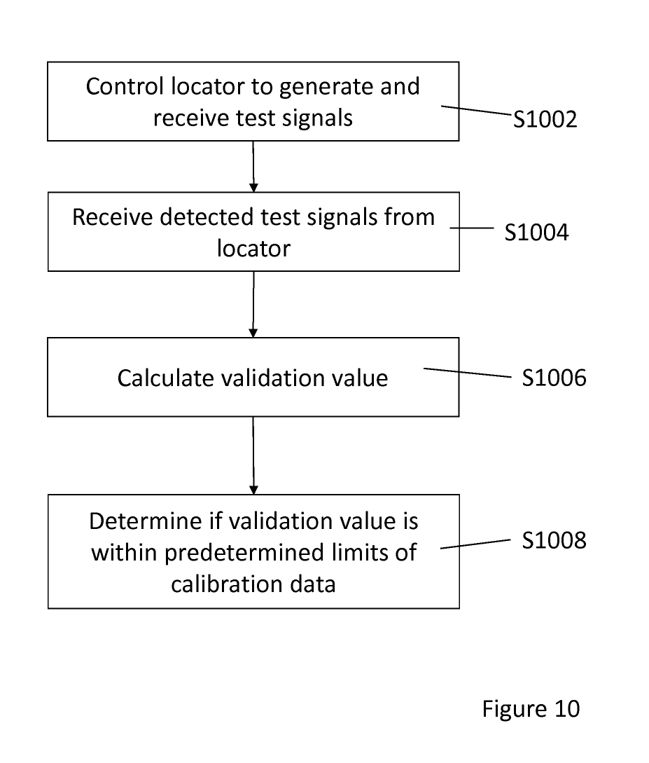

FIG. 10 shows a method carried out on a computing device such as the personal computer 33, or the smartphone 35 to validate the operation of the locator 800.

In step S1002, the computing device controls the locator 800 to generate the test signal in the transmission antenna 110 and to receive the test signal in the first reception antenna 120 and the second reception antenna 130. The signals are generated and received as described above in relation to FIGS. 5, 6, 7a, 7b and 7c. The detected test signals are then digitised by the ADCs in the locator 800. The interface unit 860 of the locator 800 then sends the digitised detected test signals to the computing device.

The computing device receives the digitised detected test signals in step S1004.

In step S1006, the computing device calculates a validation value from the digitised detected test signals.

In step S1008, the computing device determines whether the validation value is within predetermined limits of the calibration data.

In an embodiment, the computing device retrieves the calibration data from the storage device 41 coupled to server 39 using an identifier of the locator 800. The computing device may determine the identifier of the locator 800 from data stored on the locator 800.

In an alternative embodiment, the computing device may determine the calibration data from data stored on the locator.

In an embodiment, if the validation data is within the predetermined limits of the calibration data, the personal computer 33 generates a certificate to show that the locator has passed the validation test. The certificate may be printed by the printer 43 coupled to the personal computer 33.

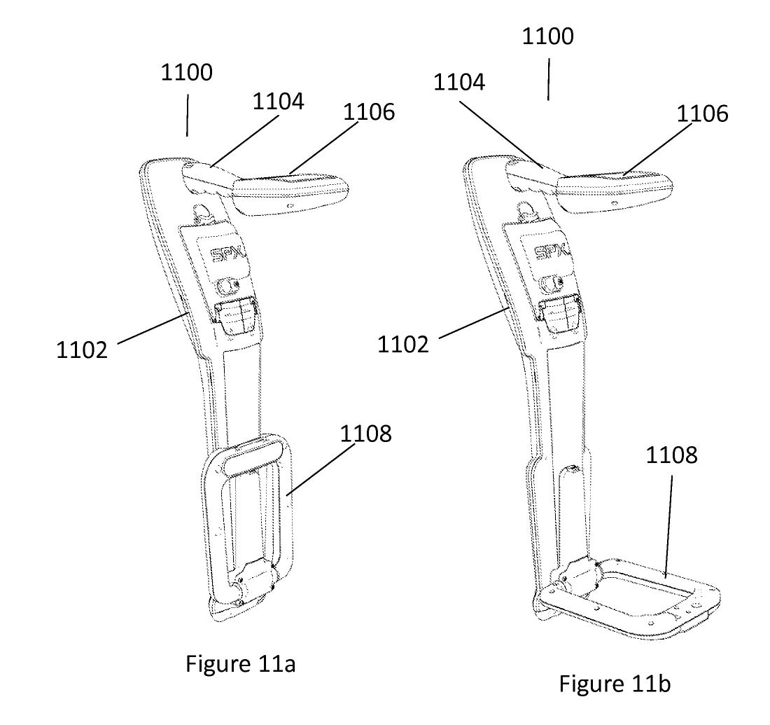

FIGS. 11a and 11b show a locator 1100 according to an embodiment. The locator 1100 is contained within a housing 1102. The housing 1102 comprises a handle 1104 which is held by a user during use. Adjacent to the handle is a display 1106 which displays indications to a user, for example the results of the validation test. The housing 1102 has a section which extends from the handle towards the ground during use. The transmission antenna 1108 is located at the opposite end of the housing from the handle 1104 and is foldable away from the housing.

FIG. 11a shows the transmission antenna 1108 in a folded position and FIG. 11b shows the transmission antenna 1108 in an unfolded position.

In an embodiment, the validation test described above is carried out in the folded position. It is noted that in the folded position, the transmission antenna will have its axis substantially perpendicular to the axes of the reception antennas which are within the housing, this means that the received power of the test signal will be reduced. As discussed above, this may be advantageous as it avoids saturation of the reception antennas.

In an alternative embodiment, the validation test described above is carried out with the transmission antenna in the unfolded position. In use in the marker locate mode, the transmission antenna is positioned in the unfolded position.

In an embodiment the locator is also operable to locate buried conductors such as cables or pipes by detecting magnetic fields emitted by the buried conductor. The locator may have a dual locate mode in which information on the location of buried electronic markers and information on the location of buried conductors is provided to the user at the same time.

While in FIGS. 11a and 11b the transmission antenna is shown as being foldable, in an alternative embodiment, the transmission antenna may be fixed in position. Such alternative embodiments could use a transmit coil wound around a core of magnetically permeable material, such as a ferrite rod. The core acts to concentrate the magnetic flux, enabling the coil to be made smaller than an air cored antenna of equivalent capability. Such a transmit coil could be concealed inside the locator.

In addition to the validation of the locator as described above, the operation of the reception antennas may be validated using windings around each of the transmission antennas as described in United Kingdom Patent application 0803873.9, the content of which is incorporated herein by reference.

The digital domain signal processing described above may be implemented in FPGA, DSP or microcontroller devices, or split across some combination of the aforementioned devices.

Aspects of the present invention can be implemented in any convenient form, for example using dedicated hardware, or a mixture of dedicated hardware and software for the processing of the signals. The computing devices and processing apparatuses can comprise any suitably programmed apparatuses such as a general purpose computer, personal digital assistant, mobile telephone (such as a WAP or 3G-compliant phone) and so on. Since the processing of the present invention can be implemented as software, each and every aspect of the present invention thus encompasses computer software implementable on a programmable device. The computer software can be provided to the programmable device using any conventional carrier medium. The carrier medium can comprise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid state memory device.

The present invention has been described above purely by way of example. Modifications in detail may be made to the embodiments within the scope of the claims appended hereto.

1. A locator for locating a buried electromagnetic marker, the locator comprising:
a transmission antenna for generating a first oscillatory magnetic field to couple with an electromagnetic marker; and
a first reception antenna for receiving an oscillatory magnetic field emitted by the electromagnetic marker,
the transmission antenna being configured to generate a test oscillatory magnetic field,
the first reception antenna being configured to receive the test oscillatory magnetic field and thereby generate a first detected test signal,
the locator further comprising a first analogue to digital converter configured to generate a first digitised test signal from the first detected test signal, the first digitised test signal being indicative of the test oscillatory magnetic field received by the first reception antenna.

2. A locator according to claim 1, further comprising:
a memory storing calibration data; and
a processor configured to calculate a validation value from the first digitised test signal and determine if the validation value is within predetermined limits of the calibration data.

3. A locator according to claim 1, further comprising:
a second reception antenna for receiving an oscillatory magnetic field emitted by the electromagnetic marker, the second reception antenna being configured to receive the test oscillatory magnetic field and thereby generate a second detected test signal,
the locator further comprising a second analogue to digital converter configured to generate a second digitised test signal from the second detected test signal, the second digitised test signal being indicative of the test oscillatory magnetic field received by the second reception antenna.

4. A locator according to claim 3, further comprising:
a memory storing calibration data; and
a processor configured to calculate a validation value from the first digitised test signal and the second digitised test signal and determine if the validation value is within predetermined limits of the calibration data.

5. A locator according to claim 1, wherein the first oscillatory magnetic field comprises a plurality of pulses having a first pulse width, and the test oscillatory magnetic field comprises a plurality of pulses having a second pulse width, the second pulse width being shorter than the first pulse width.

6. A locator according to claim 1, wherein the first oscillatory magnetic field comprises a plurality of pulses having a first amplitude, and the test oscillatory magnetic field comprises a plurality of pulses having a second amplitude, the second amplitude being smaller than the first amplitude.

7. A locator according to claim 1, further comprising an interface configured to transfer the first digitised test signal to a coupled computing device.

8. A method of validating the operation of a locator for locating a buried electromagnetic marker, the method comprising:
controlling a transmission antenna of the locator to generate a test oscillatory magnetic field;
controlling a reception antenna of the locator to receive the test oscillatory magnetic field and thereby generate a first detected test signal;
calculating a validation value from the first detected test signal; and
determining if the validation value is within predetermined limits of calibration data.

9. A method according to claim 8, further comprising generating a certificate if the validation value is within the predetermined limits of the calibration data.

10. A method according to claim 8, further comprising determining an identifier of locator and retrieving the calibration data from a remote database using the identifier of the locator.

11. A method according to claim 8, wherein the transmission antenna of the locator is configured to generate a first oscillatory magnetic field to couple with an
electromagnetic marker and the test oscillatory magnetic field comprises a plurality of pulses having a second pulse width, the second pulse width being shorter than a first pulse width.

12. A method according to claim 8, wherein the transmission antenna of the locator is configured to generate a first oscillatory magnetic field to couple with an
electromagnetic marker and the test oscillatory magnetic field comprises a plurality of pulses having a second amplitude, the second amplitude being smaller than the first amplitude.

13. A computer readable carrier medium carrying computer readable instructions which when executed on a processor cause the processor to carry out a method according to claim 8.

14. A method of validating the operation of a locator for locating a buried electromagnetic marker, the method comprising:
generating a test oscillatory magnetic field in a transmission antenna of the locator;
receiving the test oscillatory magnetic field in a reception antenna of the locator and thereby generating a first detected test signal;
calculating a validation value from the first detected test signal; and
determining if the validation value is within predetermined limits of calibration data.

15. A method according to claim 14, further comprising disabling the locator if the validation value is not within the predetermined limits of the calibration data.
